(19) United States
(12) Patent Application Publication
(10) Pub. No.: US 2022/0019322 A1
(43) Pub. Date: Jan. 20, 2022

(54) INFORMATION PROCESSING APPARATUS

(71) Applicant: FUJIFILM BUSINESS INNOVATION CORP., Tokyo (JP)

(72) Inventor: Kiyoshi TAKAHASHI, Kanagawa (JP)

(73) Assignee: FUJIFILM BUSINESS INNOVATION CORP., Tokyo (JP)

(21) Appl. No.: 17/141,388

(22) Filed: Jan. 5, 2021

(30) Foreign Application Priority Data
Jul. 20, 2020 (JP) 2020-123609

(51) Int. Cl. G06F 3/0485

(52) U.S. Cl. CPC G06F 3/0485

(57) ABSTRACT

An information processing apparatus includes a processor configured to acquire (i) a list of combinations of an image and a recognition result of the image and (ii) information regarding certainty factors of the recognition results, display the list in a display region in a scrollable manner, and scroll the list in response to a predetermined operation, and a scrolling speed of the scrolling is controlled in accordance with the certainty factors.

### CROSS-REFERENCE TO RELATED APPLICATIONS

This application is based on and claims priority under 35 USC 119 from Japanese Patent Application No. 2020-123609 filed Jul. 20, 2020.

### BACKGROUND

### (i) Technical Field

The present disclosure relates to an information processing apparatus.

### (ii) Related Art

In a standard procedure of a data entry system, to reduce the occurrence of error caused by manual entry, two people are required to read and enter the same character-string image, and the entry is adopted if the entries by the two people coincide with each other.

Recent years have seen the development of a system that adopts a procedure in which a character-string image is processed by using optical character recognition (OCR), and a result of the character recognition obtained by using OCR (hereinafter, referred to as a character-recognition result) is checked by a person for an error, which is then corrected. Such a system can reduce the amount of work to be done by people compared with a conventional system, which requires two people, and simultaneously achieve an error rate comparable with the conventional system.

A usual paper input form from which data is obtained for entry has a plurality of input boxes, and an operator processes a large number of paper input forms at one time. Thus, some data entry systems using OCR have a function in which each of the images in a plurality of entry boxes on one or more input forms is combined with a character-recognition result obtained for the image and the combinations are listed and presented on a screen to improve the operator efficiency. The operator scrolls the list presented on the screen and checks whether the character-recognition result in each combination on the list is correct, and if an incorrect character-recognition result is found, the operator corrects the error by manual input.

The list is scrolled not only by a method in which an arrow key in a keyboard or in a graphical user interface (GUI) is pressed to scroll line by line but also by a method in which an operation such as holding down an arrow key scrolls the list continuously at a fixed speed.

Examples of a method for controlling a scrolling speed of a screen include the following technologies in the related-art.

A display control apparatus disclosed in Japanese Unexamined Patent Application Publication No. 2006-236286 includes a screen display unit, a screen scrolling unit, and a scrolling control unit. The screen display unit displays a screen including a plurality of images, and the screen is scrolled at a predetermined speed by the screen scrolling unit. The scrolling control unit controls scrolling so as to render the scrolling speed slower than the predetermined speed or stop scrolling if a screen including at least a portion of a specified image, which is an image specified in advance, is displayed during the scrolling.

In a method disclosed in Japanese Unexamined Patent Application Publication No. 2001-282414, a document is scrolled and displayed line by line in response to a scrolling command that is sent by a user every time the user reads a line in the document on a display screen, and a character reading speed of the user is detected by using the intervals between the scrolling commands and the number of characters in a line in the document. In addition, the organization of the document is detected by using the type and the number of characters included in the document, the ratio between characters and figures in the document, and other information regarding the document, and the scrolling speed is set based on the organization and the character reading speed of the user. Then, image data corresponding to one screen is extracted from the image data of the document information while the extracted region is moved line by line, and the image data corresponding to one screen is output to a display with timings based on the scrolling speed that has been set in advance. Then the document is scrolled line by line and displayed by the display.

In a map display apparatus disclosed in Japanese Patent No. 3589229, a scrolling control unit renders a scrolling speed slower when the position pointed by a cursor is located in a candidate area suitable for driving than when the position pointed by the cursor is located in a candidate area unsuitable for driving, renders the scrolling speed faster when the position pointed by the cursor is located in the candidate area unsuitable for driving than when the position pointed by the cursor is located in the candidate area suitable for driving, and maintains the same scrolling speed when the position pointed by the cursor is located neither in the candidate area suitable for driving nor in the candidate area unsuitable for driving.

### SUMMARY

If each image is combined with a recognition result of the image and the list of the combinations is scrolled at a fixed speed, too fast a scrolling speed leads to an increase in the possibility that an error in a recognition result escapes detection. In contrast, too slow a scrolling speed leads to too much time required to finish checking of all the recognition results on the list.

Aspects of non-limiting embodiments of the present disclosure relate to shortening the time required to check an entire list of combinations each formed of an image and a recognition result of the image while reducing the possibility that an error escapes detection compared with a method in which the list is scrolled at a fixed speed and displayed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to acquire (i) a list of combinations of an image and a recognition result of the image and (ii) information regarding certainty factors of the recognition results, display the list in a display region in a scrollable manner, and scroll the list in response to a predetermined operation, and a scrolling speed of the scrolling is controlled in accordance with the certainty factors.

### BRIEF DESCRIPTION OF THE DRAWINGS

An exemplary embodiment of the present disclosure will be described in detail based on the following figures, wherein:

FIG. 1 is a diagram depicting an example of a functional configuration of an information processing apparatus according to the present exemplary embodiment;

FIG. 2 illustrates a screen that is provided by a check-and-correction processor of the information processing apparatus and that includes a list-presentation section to accept confirmation of and correction to a character-recognition result;

FIGS. 3A, 3B, and 3C are illustrations for describing a method to control a speed of scrolling a list according to the present exemplary embodiment;

FIG. 4 is a diagram illustrating a procedure to control the speed of scrolling a list according to the present exemplary embodiment;

FIG. 5 is an illustration depicting an example of an informing screen according to a first modification;

FIG. 6 is an illustration for describing presentation of a rechecking list;

FIGS. 7A, 7B, and 7C are illustrations for describing changes in the presentation due to scrolling according to a second modification; and

FIG. 8 is an illustration depicting an example of a hardware configuration of a computer.

### DETAILED DESCRIPTION

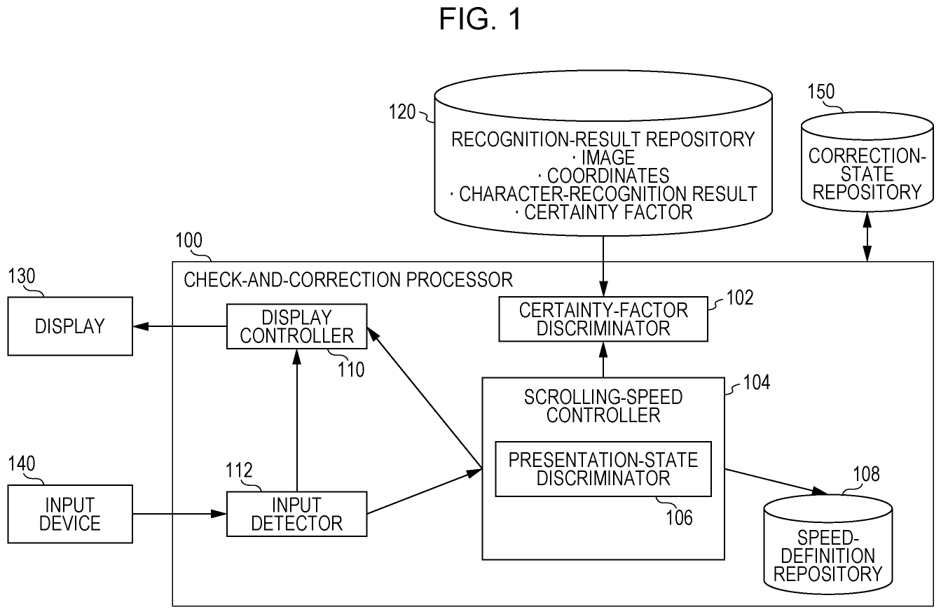

FIG. 1 illustrates a functional configuration of an exemplary embodiment of an information processing apparatus according to the present disclosure. This information processing apparatus is used, for example, as a subsystem of a data entry system using OCR, and the subsystem is used to enable a user (or a human operator) to check a character-recognition result obtained by using OCR and to correct possible errors. The information processing apparatus includes a check-and-correction processor 100, a recognition-result repository 120, a display 130, an input device 140, and a correction-state repository 150.

The recognition-result repository 120 stores recognition result data obtained as a result of a character-recognition process performed by an OCR system, which is not depicted, on a scan image of an input form. For each input form, the recognition result data includes a scan image of the input form and information regarding each box on the input form. Examples of information regarding each box include coordinates of the box in the scan image, character-string data of a character-recognition result obtained for the box, and the certainty factor of the character-recognition result. The certainty factor is a value indicating the likelihood of the character-recognition result being correct, and from another point of view, may be understood as the probability that the character-recognition provides a correct recognition result. The certainty factor is associated with the character-recognition result and output by the OCR system. The recognition-result repository 120 is formed by using a large-volume auxiliary storage device, such as a hard disk, for example, included in the information processing apparatus.

The check-and-correction processor 100 provides a user with a screen presenting a character-recognition result of an input form, the character-recognition result being stored in the recognition-result repository 120, and accepts from the user via the screen input of confirmation of a character-recognition result and of correction to an incorrect character-recognition result. Examples of a screen provided by the check-and-correction processor 100 to the user include a screen in which a list of combinations each formed of an image in one of a plurality of boxes and a character-recognition result of the image is presented so that the character-recognition results of the images in the plurality of boxes can be consecutively checked.

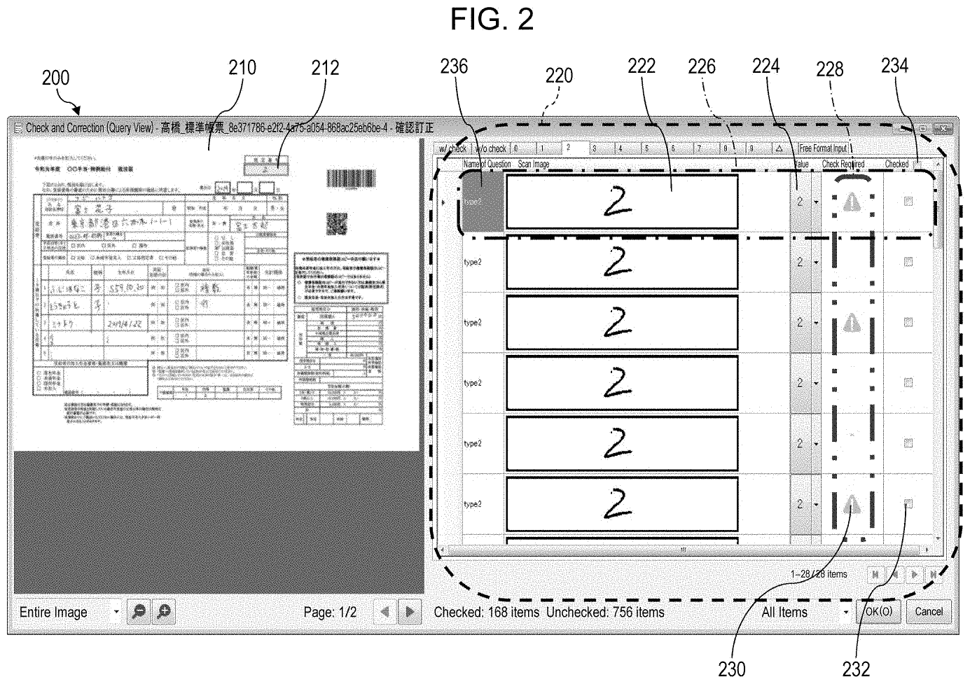

FIG. 2 depicts an example of a screen 200 presenting a list of combinations each formed of an image in a box on an input form and a character-recognition result of the image. An input-form-image presentation section 210 constitutes the left half of the screen 200 and presents a scan image of an input form. A list-presentation section 220 constitutes the right half of the screen 200 and presents a list of combinations, each combination 226 being formed of an image 222 of an entry box on an input form and a character-recognition result 224. By way of example only, the example depicted in FIG. 2 illustrates the list-presentation section 220, in which the image 222 is combined with the character-recognition result 224 (which is “2” in this case), forming the combination 226, which is presented in the list. Of all the entry boxes included in a plurality of input forms, the image 222 is obtained from an entry box that has the numeral “2” as the character-recognition result 224. The image 222 is the image obtained from the entry box in the scan image of an entire input form. The character-recognition result 224 represents character-string data obtained by the OCR system from the image 222 as a result of character recognition.

A presentation section for the combination 226 includes a check-required mark box 228, a confirmation check box 232, and a number box 236.

If the certainty factor of the character-recognition result 224 in the combination 226 is below a predetermined threshold, a check-required mark 230 is presented in the check-required mark box 228. Otherwise, the check-required mark box 228 is left blank. If the certainty factor is low (that is, below the threshold), it is likely that the character-recognition result 224 is incorrect, thus it is likely that the user needs to visually check whether the character-recognition result 224 is correct. Thus, if the certainty factor is below the threshold, the check-required mark 230 is presented to attract attention of the user.

After the user confirms the character-recognition result 224 in the combination 226, a check mark is entered in the confirmation check box 232. For example, if the user visually compares the image 222 with the character-recognition result 224 in the combination 226 and determines that the character-recognition result 224 is correct as a result of comparison, the user enters a check mark in the confirmation check box 232. In addition, after the user corrects the character-recognition result 224, a check mark is entered in the confirmation check box 232.

A collective-confirmation check box 234 is used to collectively enter check marks in the confirmation check boxes 232 in all the combinations on the list. For example, the user makes a quick check of combinations having no check-required mark 230 in scrolling presentation and checks the collective-confirmation check box 234 after the entire list is checked. With this operation, all the combinations on the list go into a checked state.

The number box 236 is used to present the consecutive number assigned to the combination 226 on the list. Further, the number box 236 of the combination 226 where the focus (that is, the cursor) is located in the list is highlighted. In the depicted example, the focus is located at the topmost combination 226 in the presentation. The input-form-image presentation section 210 presents the image of the input form containing the entry box that corresponds to the combination 226, where the focus is located. In addition, an entry box 212 that corresponds to the combination 226 in the image of the input form presented in the input-form-image presentation section 210 is highlighted.

The user can move the position of the focus, for example, by pressing arrow keys on the keyboard of the information processing apparatus. For example, the user can move the position of the focus to the next lower combination by pressing the down-arrow key in the depicted situation. Further, for example, holding down the down-arrow key causes the information processing apparatus to move the position of the focus downward at a fixed speed in the same way as consecutively pressing the key at regular intervals. If the position of the focus further keeps moving downward after the position of the focus reaches the lowermost combination 226 presented in the list-presentation section 220, the list presented in the list-presentation section 220 is scrolled, and the combination 226 just below the lowermost combination 226 is presented. In this way, if the arrow key continues to be held down, the list presented in the list-presentation section 220 is continuously scrolled. The presentation mode in which the list is continuously scrolled in this way is referred to as continuous scrolling presentation.

In the example in FIG. 2, the list presented in the list-presentation section 220 is formed of combinations in each of which a character or a character string obtained as a character-recognition result has a specific value (the numeral “2” in the example in FIG. 2) by way of example only. Other examples of a list that can be presented in the list-presentation section 220 include a list of combinations formed of images of entry boxes of a specific type (for example, the “name” entry boxes) on a plurality of input forms and the corresponding character-recognition results and a list of combinations formed of images of all the entry boxes on a single input form and the corresponding character-recognition results.

Referring back to FIG. 1, a display controller 110 of the check-and-correction processor 100 performs display control of the screen 200, and the display control has been described with reference to FIG. 2. In the related art, for example, the list presented in the list-presentation section 220 is scrolled at a fixed speed while the down-arrow key is held down. However, if the fixed speed is too fast, the user cannot sometimes adequately check an individual character-recognition result, in particular, in the combinations 226 having the check-required mark 230, which indicates the necessity for a check. In contrast, if the fixed speed is set slow, while adequate time to check the character-recognition results is ensured, the total time required to perform a check-and-correction operation on a number of combinations increases.

Thus, in the present exemplary embodiment, the scrolling speed of a list in the list-presentation section 220 is controlled in accordance with the certainty factor of each character-recognition result. For example, while a character-recognition result having the certainty factor lower than a threshold is presented, the scrolling speed is rendered slower than while no character-recognition result having the certainty factor lower than the threshold is presented. In other words, the scrolling speed is rendered higher in the case where the certainty factor is equal to or higher than the threshold for all the presented character-recognition results than in the case where at least one presented character-recognition result has the certainty factor lower than the threshold.

For such scrolling speed control, the check-and-correction processor 100 includes a certainty-factor discriminator 102, a scrolling-speed controller 104, and a speed-definition repository 108.

The certainty-factor discriminator 102 determines whether the certainty factor of each combination included in a list is equal to or higher than a predetermined threshold. This threshold may be the same as the threshold used to determine whether the check-required mark 230 is presented. To create presentation for the list-presentation section 220, the check-and-correction processor 100 creates by using pieces of recognition-result data retrieved from the recognition-result repository 120 a list of combinations that satisfy a requirement specified by the user (for example, a requirement “the character-recognition result is the numeral ‘2’”). When the check-and-correction processor 100 presents the list in the list-presentation section 220 in a manner that allows scrolling, the certainty-factor discriminator 102 makes the determination described above and adds to the data of each combination on the list the result of the determination, which is a value that indicates whether the certainty factor of the combination is equal to or higher than the threshold or lower than the threshold. Data of the list to which the results of the determination have been added is delivered to the scrolling-speed controller 104.

The scrolling-speed controller 104 controls the scrolling speed in the continuous scrolling presentation for the list-presentation section 220 in accordance with the results of the determination by the certainty-factor discriminator 102. The continuous scrolling presentation is provided by an operation such as holding down an arrow key. The scrolling-speed controller 104 includes a presentation-state discriminator 106. The presentation-state discriminator 106 determines whether the combinations presented in the display region of the list-presentation section 220 include at least one combination whose certainty factor is lower than the threshold. If the determination is negative (namely “no combination whose certainty factor is lower than the threshold is present in the display region”), the scrolling-speed controller 104 sets the scrolling speed in the continuous scrolling presentation at a predetermined first speed. If the determination is affirmative (namely “at least one combination whose certainty factor is lower than the threshold is present in the display region”), the scrolling-speed controller 104 sets the scrolling speed in the continuous scrolling presentation at a predetermined second speed that is slower than the first speed. The definition of the scrolling speed for each determination provided by the presentation-state discriminator 106, namely the information that determines values of the first speed and the second speed described above, is stored in the speed-definition repository 108. In the continuous scrolling presentation, the scrolling-speed controller 104 scrolls a list presented in the list-presentation section 220 at a speed set in accordance with a result of determination regarding the certainty factor. The information that determines the first speed and the second speed and that is stored in the speed-definition repository 108 may be customized by the user.

The display controller 110 creates an image of the screen 200 including the list-presentation section 220 and causes the display 130 to display the image. The display 130 is a device that displays an image by using such a technology as a liquid-crystal or organic electroluminescence technology.

An input detector 112 detects input from the user by using the input device 140 such as a keyboard and mouse. Concerning continuous scrolling of a list in the list-presentation section 220, the input detector 112 detects input related to scrolling of the list, such as pressing an arrow key on the keyboard and a command through the mouse for continuous scrolling (for example, an operation of rolling a wheel on the mouse).

The information processing apparatus may include an input/output device that integrates the display 130 and the input device 140, such as a touch panel display. If a touch panel display is used, the input detector 112 detects a predetermined gesture to send a command to continuously scroll a list.

The correction-state repository 150 stores a result of confirmation of or correction to a character-recognition result in each combination on a list. The confirmation or the correction is performed by the user. For example, for each combination, the correction-state repository 150 stores the information indicating whether the combination has been confirmed by the user (namely, a check mark has been entered in the confirmation check box 232). In addition, if there is a character-recognition result corrected by the user, the correction-state repository 150 stores data of the corrected character-recognition result.

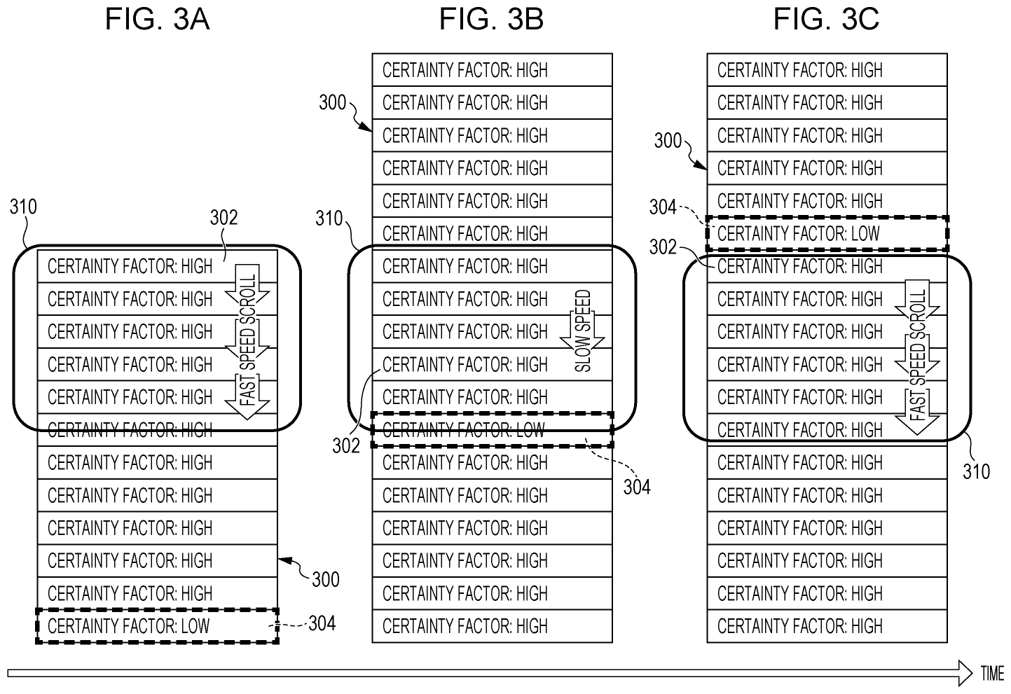

Next, referring to a specific example depicted in FIGS. 3A, 3B, and 3C, a description will be given of a scrolling speed control for a list in the continuous scrolling presentation according to the present exemplary embodiment.

FIGS. 3A, 3B, and 3C illustrate a temporal change in a relationship between a list 300 to be presented and a display region 310 of the list-presentation section 220 in the continuous scrolling presentation. FIG. 3A in the leftmost column schematically represents a situation in the illustrated example at the earliest time. In this situation, the leading part of the list 300 is presented in the display region 310. By way of example only, consecutive six combinations on the list 300 can be presented in the column direction of the display region 310 in the illustrated example. The combinations on the list 300 are classified into combinations having the “high certainty factor” 302 and combinations having the “low certainty factor” 304. A combination having the “high certainty factor” 302 has the certainty factor equal to or higher than the threshold, and a combination having the “low certainty factor” 304 has the certainty factor lower than the threshold. In the situation depicted in FIG. 3A, only combinations having the “high certainty factor” 302 are presented in the display region 310, and no combination having the “low certainty factor” 304 is presented in the display region 310. Although details are omitted in the Figures to avoid complexity, presented images of a combination having the “high certainty factor” 302 and a combination having the “low certainty factor” 304 in the display region 310 each include an image 222 and a character-recognition result 224 corresponding to the image 222, and the image 222 and the character-recognition result 224 are similar to those illustrated in FIG. 2. In addition, each presented image may include the check-required mark box 228 or the confirmation check box 232 for the combination. If the user holds down the down-arrow key on the keyboard and sends a command to provide the continuous scrolling presentation in this situation, the display region 310 continuously moves downward with respect to the list 300. The scrolling speed of the list 300 is the first speed, which is relatively high, at this time.

As the scrolling continues, a situation depicted in FIG. 3B appears. In this situation, the upper part of a combination having the “low certainty factor” 304, which is located downward away from the display region 310 at the time depicted in FIG. 3A, starts to enter the display region 310. In this way, if at least part of the presented image of the combination having the “low certainty factor” 304 enters the display region 310, the scrolling-speed controller 104 changes the scrolling speed in the continuous scrolling presentation to the second speed, which is slower than the first speed. As long as at least one combination having the “low certainty factor” 304 thereafter remains in the display region 310, the scrolling speed in the continuous scrolling presentation is the second speed.

As the scrolling further continues, the at least one combination having the “low certainty factor” 304 moves upward and out of the display region 310. FIG. 3C represents the situation in this condition. A number of combinations having the “high certainty factor” 302 consecutively follow the at least one combination having the “low certainty factor” 304 on the list 300 in the downward direction. Thus, in the situation depicted in FIG. 3C, only the combinations having the “high certainty factor” 302 are lined up in the display region 310. At this time, the scrolling-speed controller 104 changes the scrolling speed in the continuous scrolling presentation to the first speed (fast speed). The first speed is thereafter maintained until the scrolling continues and another combination having the “low certainty factor” 304 enters the display region 310.

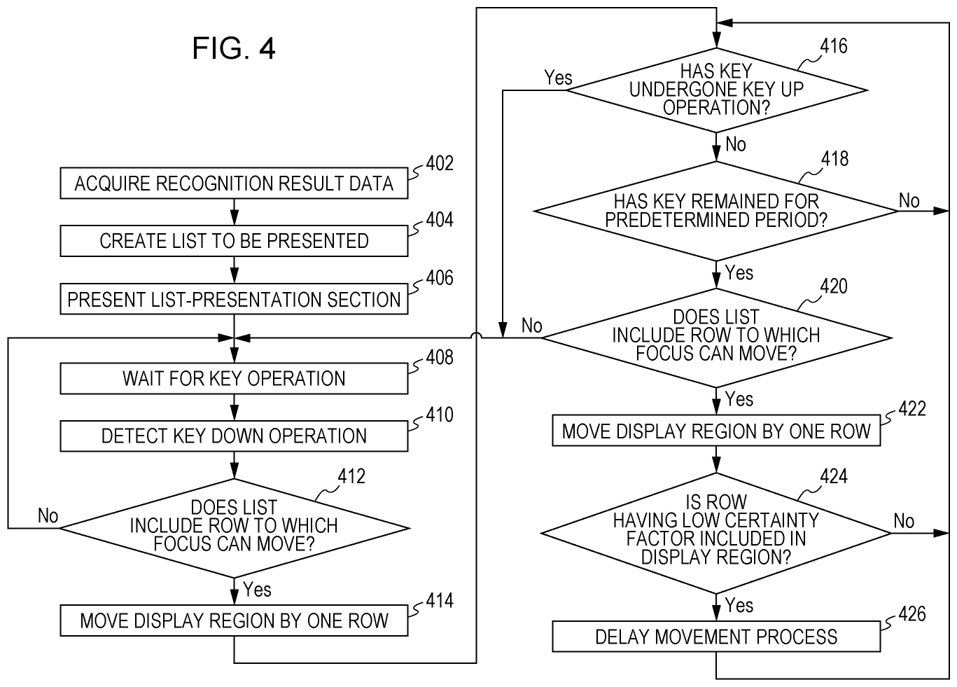

Next, referring to FIG. 4, a description will be given of an example procedure of controlling the scrolling presentation in the list-presentation section 220.

In this procedure, the check-and-correction processor 100 acquires recognition result data from the recognition-result repository 120 (402). In response to receiving a command to present a list in the list-presentation section 220 from a user, the check-and-correction processor 100 also creates a list to be presented in the list-presentation section 220 by using the recognition result data (404). The list created at this time is a list of combinations that satisfy a presentation requirement (for example, in the example in FIG. 2, combinations whose character-recognition results are the numeral “2”). The data of each combination included in the list includes an image, character-string data of a character-recognition result obtained for the image, and a certainty factor. Further, at this time, the certainty-factor discriminator 102 determines whether the certainty factor in each combination included in the list is equal to or higher than the threshold and add the determination result to the data of the combination.

Next, the check-and-correction processor 100 causes the display 130 to present the screen 200 including the list-presentation section 220 in which the list is presented (406). The input detector 112 of the check-and-correction processor 100 waits for a key operation to be performed to scroll the list in the list-presentation section 220 (408). The key operation to scroll the list is, for example, pressing the up-arrow key or the down-arrow key (the so-called “key down” operation). In response to detecting that a key down operation of the up-arrow key or the down-arrow key is performed (410), the process proceeds to step 412. In step 412, the scrolling-speed controller 104 determines whether the list includes another row or another combination to which the position of the focus can move in the direction pointed by the key subjected to a key down operation with respect to a displayed portion in the list-presentation section 220. If the determination in step 412 is negative (No), the scrolling-speed controller 104 does not scroll the list in the list-presentation section 220 and returns to step 408. If the determination in step 412 is affirmative (Yes), the display region 310 of the list-presentation section 220 is moved in the direction pointed by the key by one row (or one combination) (414).

After step 414, the input detector 112 determines whether the key in the key down state has undergone a key up operation (that is, exited from the key down state) (416). If the determination in step 416 is affirmative, the scrolling-speed controller 104 returns to step 408. If the determination in step 416 is negative, the scrolling-speed controller 104 determines whether the key has remained in the key down state for a predetermined period (418). If the determination in step 418 is negative, the scrolling-speed controller 104 returns to the process in step 416.

An affirmative determination in step 418 indicates that the key pressed in step 410 is held down. In this case, the scrolling-speed controller 104 provides the continuous scrolling presentation in the direction pointed by the key. In other words, as in step 412, the scrolling-speed controller 104 determines whether the list includes another combination in the direction pointed by the key with respect to a portion of the list presented in the display region 310 of the list-presentation section 220 (420). If the determination is affirmative, the display region 310 is moved in the direction pointed by the key by one row or one combination (422). This operation scrolls the list in the display region 310 by one row. The scrolling-speed controller 104 thereafter determines whether at least one combination having the “low certainty factor” 304 is included in the display region 310 (424). If the determination is affirmative, the scrolling-speed controller 104 delays the movement of the display region 310 or scrolling for a predetermined period (426). After the delay of the predetermined period, the scrolling-speed controller 104 returns to step 416. If the determination in step 424 is negative, the scrolling-speed controller 104 returns to step 416 without a delay in scrolling (426). While the key pressed in step 410 is held down and no combination having the “low certainty factor” 304 is present in the display region 310, a loop starting from and returning to step 416 via steps 418, 420, 422, and 424 is repeated. During this loop, the list in the display region 310 is scrolled at a fast speed because the delay of the predetermined period in scrolling (426) is not included. While the key pressed in step 410 is held down and at least one combination having the “low certainty factor” 304 is present in the display region 310, a loop starting from and returning to step 416 via steps 418, 420, 422, 424, and 426 is repeated. During this loop, the list in the display region 310 is scrolled at a slow speed because the delay of the predetermined period in scrolling (426) is included.

If the determination in step 420 is negative, that is, the list cannot be scrolled further, the scrolling-speed controller 104 returns to step 408 and waits for a next key operation.

As described above, the information processing apparatus according to the present exemplary embodiment renders the scrolling speed slower while at least one combination having the “low certainty factor” 304 is present in the display region 310 (or in the list-presentation section 220) than while no combination having the “low certainty factor” 304 is present in the display region 310. This operation causes the at least one combination having the “low certainty factor” 304 to move slowly in the display region 310, allowing the user to spend enough time in determining whether the character-recognition result in each of the at least one combination having the “low certainty factor” 304 needs correction. Each of the at least one combination having the “low certainty factor” 304, which is presented in the display region 310, may be presented in association with the check-required mark 230, which is similar to the one illustrated in FIG. 2.

In addition, during the continuous scrolling presentation, the user may enter confirmation input or correction input if the user determines that the character-recognition result 224 in the combination having the “low certainty factor” 304 or in the combination having the “high certainty factor” 302 in the list-presentation section 220 is correct or needs correction. For example, when having confirmed that the character-recognition result 224 in the presented combination is correct, the user stops scrolling and enters a check mark in the confirmation check box 232 in the combination (refer to FIG. 2). Further, when having found an error in the character-recognition result 224 in the presented combination, the user stops scrolling and corrects the character-recognition result 224 in the combination (refer to FIG. 2). The state of the confirmation check box 232 (that is, whether there is a check mark) in each combination and a corrected value of the character-recognition result 224 in each combination are stored in the correction-state repository 150.

If the confirmation check box 232 in a combination having the “low certainty factor” 304 is checked, the scrolling-speed controller 104 may thereafter treat the combination having the “low certainty factor” 304 in the same way as a combination having the “high certainty factor” 302 in terms of scrolling-speed control. This is because the value of the character-recognition result 224 in the combination having the “low certainty factor” 304 gains a high degree of certainty after receiving the confirmation by the user and does not need to be closely examined by the user while the combination is presented again during the following scrolling of the list. For the same reason, if the character-recognition result 224 in the combination having the “low certainty factor” 304 is corrected by the user, the scrolling-speed controller 104 may also treat the combination having the “low certainty factor” 304 in the same way as the combination having the “high certainty factor” 302 in terms of scrolling-speed control. To perform this type of control, if it is found in step 424 of the procedure depicted in FIG. 4 that at least one combination having the “low certainty factor” 304 is present in the display region 310, the scrolling-speed controller 104 checks whether the confirmation check box 232 in the combination is checked and whether correction is made to the combination. If it is found as a result of this check that the confirmation check box 232 in the combination is checked or that the combination has been corrected, the scrolling-speed controller 104 makes a negative determination (No) in step 424.

### First Modification

If the scrolling speed is decreased by the scrolling-speed control described above while a combination having the “low certainty factor” 304 is presented, the user still sometimes overlooks an error in a character-recognition result in the combination and continues scrolling without correcting the error. An adverse effect caused by a failure by the user to check a combination having the “low certainty factor” 304 is greater than an adverse effect caused by a failure to check a combination having the “high certainty factor” 302 because of low credibility of a character-recognition result obtained by OCR for the combination having the “low certainty factor” 304.

To reduce an adverse effect caused by the failure to check the combination having the “low certainty factor” 304, the check-and-correction processor 100 provides the user, for example, with information regarding the presence of a combination having the “low certainty factor” 304 that should have been viewed by the user but that has been neither confirmed (that is, the confirmation check box 232 is not checked) nor corrected. The information is provided, for example, at the time that all the combinations on a list have been presented or that the focus operated by the user moves out of the list-presentation section 220 (for example, in the case where an item outside the list-presentation section 220 in the screen 200 in FIG. 2 is clicked and the focus is shifted).

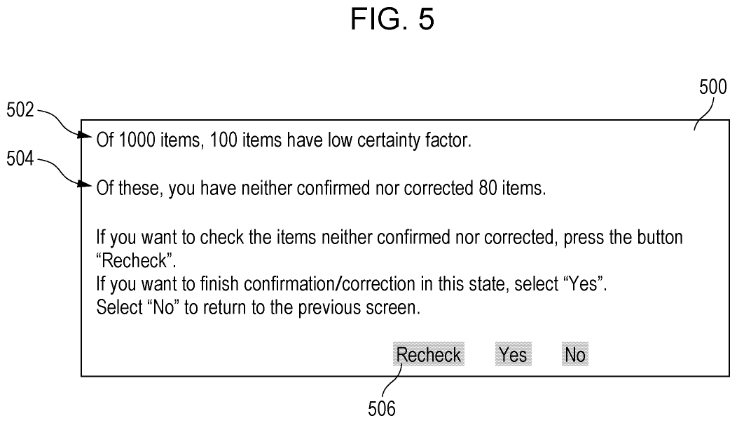

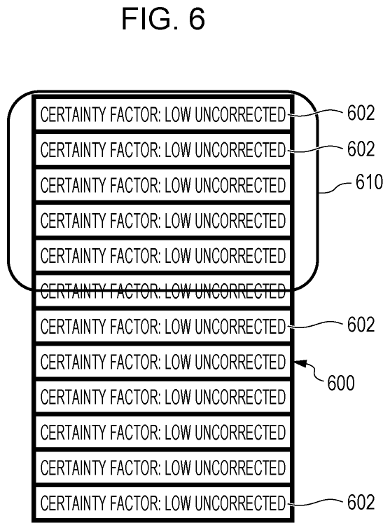

FIG. 5 illustrates an example of a screen 500 for the information. The screen 500 presents a message 504 indicating the number of combinations that have been neither confirmed nor corrected by the user on the list checked at this time. In addition, the screen 500 may present a message 502 indicating a general condition of the list, for example, the number of combinations included in the list and the number of combinations having the “low certainty factor” 304 of all the combinations. Further, the screen 500 presents a “Recheck” button 506. If the user performs a mouse operation or the like and presses the “Recheck” button 506, the check-and-correction processor 100 presents a rechecking list 600 in the list-presentation section 220 (refer to FIG. 2) or in a newly opened window, as illustrated in FIG. 6. Of the combinations having the “low certainty factor” 304 on the list 300 to be checked by the user, only combinations 602 that have been neither confirmed nor corrected in the operation at this time are extracted and arranged in the rechecking list 600. If the rechecking list 600 is longer than a display region 610 of the list-presentation section 220 or of the newly opened window, the rechecking list 600 is presented in the display region 610 so as to be scrolled.

In this modification, to determine whether the user has viewed a combination on a list, for example, the check-and-correction processor 100 records whether the focus is placed on the combination while the list-presentation section 220 is presented. For example, in the example in FIG. 2, the focus is placed on the topmost row (or combination) in the list-presentation section 220, and the focus thereafter moves downward row by row while the down-arrow key is held down. Then, when the focus reaches the bottom row, the presented list is consecutively scrolled upward. While the list is scrolled, the focus stays at the bottom row in the list-presentation section 220, and a combination on which the focus is placed consecutively changes as the list is scrolled. Every time the focus is moved from one row to a next row in step 414 or 422 in the procedure in FIG. 4, the check-and-correction processor 100 changes the focus flag of the data of a row or a combination on which the focus is newly placed on the list to a value representing “focused”. The focus flag of a combination indicates whether the focus has been placed on the combination (“focused”) or whether the focus has not been placed on the combination (“unfocused”). When the list is presented on the screen 200 for the first time, the focus flags of all the combinations on the list are initialized to “unfocused”.

In another example, if the list is scrolled until the end of the list is presented after the leading part of the list is presented in the list-presentation section 220, the check-and-correction processor 100 may determine that the user has viewed all the rows or combinations included in the list.

### Second Modification

A description will be given of another modification by which to cope with a failure to check a combination having the “low certainty factor” 304 when a list is scrolled.

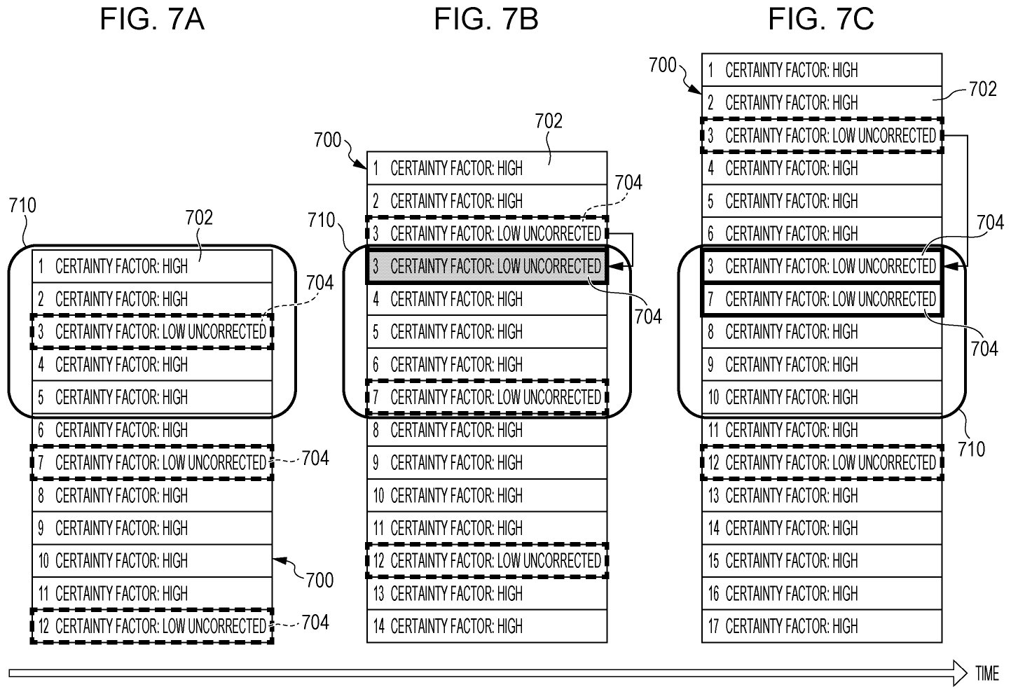

In this modification, once presented in the list-presentation section 220, a combination having the “low certainty factor” 304 is controlled to remain in the list-presentation section 220 while the list is scrolled until the combination undergoes at least one of confirmation and correction by the user. With reference to FIGS. 7A, 7B, and 7C, a description will be given of an example of this control performed by the check-and-correction processor 100.

As in the example in FIGS. 3A to 3C, FIGS. 7A, 7B, and 7C illustrate a temporal change in a relationship between a list 700 to be presented and a display region 710 of the list-presentation section 220 in the continuous scrolling presentation.

FIG. 7A in the leftmost column schematically represents a situation in the illustrated example at the earliest time. In this situation, the leading part of the list 700 is presented in the display region 710. By way of example only, consecutive five combinations on the list 700 can be presented in the column direction of the display region 710 in the illustrated example. The combinations on the list 700 are classified into combinations having the “high certainty factor” 702 and combinations having the “low certainty factor” 704. A combination having the “high certainty factor” 702 has the certainty factor equal to or higher than a threshold, and a combination having the “low certainty factor” 704 has the certainty factor lower than the threshold. In the situation depicted in FIG. 7A, five combinations numbered one to five in the leading part of the list 700 are presented in the display region 710. Of the five combinations, a combination that is located in the center and that is numbered three is a combination having the “low certainty factor” 704, and the remaining four combinations are combinations having the “high certainty factor” 702. In FIG. 7A, a word “uncorrected” attached to a combination having the “low certainty factor” 704 indicates that the combination has been neither confirmed nor corrected by the user. If the user holds down the down-arrow key on the keyboard and sends a command to provide the continuous scrolling presentation in this situation, the scrolling speed for the list 700 is set at the second speed, which is relatively slow.

As the scrolling continues, a situation depicted in FIG. 7B appears. It is assumed that the combination having the “low certainty factor” 704, which is numbered three, has been neither confirmed nor corrected by the user up to this point. At this point, the combination having the “low certainty factor” 704, which is numbered three, should be located outside the display region 710 in the upward direction by one row in the control in the above exemplary embodiment but stays at the upper end of the display region 710 in the control in the second modification. If the scrolling further continues thereafter, the combination having the “low certainty factor” 704, which is numbered three, remains at the upper end of the display region 710, and the combinations having the “high certainty factor” 702, which are numbered four, five, and six, move upward instead and out of the display region 710.

In a situation where the scrolling further continues, which is depicted in FIG. 7C, the combinations having the “low certainty factor” 704, which are numbered three and seven, remain at the upper end of the display region 710 in this order. It is assumed that the combinations having the “low certainty factor” 704, which are numbered three and seven, have been neither confirmed nor corrected by the user up to this point. If the scrolling further continues thereafter, the combinations having the “low certainty factor” 704, which are numbered three and seven, remain at the upper end of the display region 710, and the combinations having the “high certainty factor” 702, which are numbered eight, nine, . . . , move upward instead and out of the display region 710.

In the example depicted in FIGS. 7A to 7C, while the list 700 is scrolled, a combination having the “low certainty factor” 704 that has been neither confirmed nor corrected remains in the display region 710 and is exposed to inspection by the user. For example, if the user stops scrolling the list and inputs confirmation of or correction to a combination having the “low certainty factor” 704 in the display region 710, the combination goes into a checked state or a corrected state. The check-and-correction processor 100 excludes a combination having the “low certainty factor” 704 that has been confirmed or corrected from targets to be kept in the display region 710. For example, in the situation in FIG. 7B, if the user checks the confirmation check box 232 in the combination having the “low certainty factor” 704, which is numbered three, and thereafter resumes scrolling in the same direction as before by using the down-arrow key, the combination having the “low certainty factor” 704, which is numbered three, moves upward and out of the display region 710.

If each combination presented in the display region 710 except one or more combinations having the “low certainty factor” 704 that remain at the upper end of the display region 710 due to the control in the second modification is a combination having the “high certainty factor” 702, the scrolling-speed controller 104 may set the scrolling speed at the fast speed (equal to the first speed).

In the example in FIGS. 7A to 7C, pressing the down-arrow key moves the display region 710 downward with respect to the list 700. Conversely, pressing the up-arrow key moves the display region 710 upward with respect to the list 700, and similar control is achieved. In the case of upward movement, a combination having the “low certainty factor” 704 that has been neither confirmed nor corrected is controlled to remain at the lower end of the display region 710. In summary, a combination having the “low certainty factor” 704 that has been neither confirmed nor corrected remains at either the upper end or the lower end of the display region 710, whichever corresponds to the trailing end of the display region 710 in the moving direction with respect to the list 700.

As the number of combinations having the “low certainty factor” 704 that remain in the display region 710 increases, the number of combinations that are presented and actually scrolled in the display region 710 decreases. At the extreme, if the number of remaining combinations having the “low certainty factor” 704 reaches the maximum number of combinations that can be presented in the display region 710, further scrolling does not change the presentation. In this case, if the list 700 continues to be scrolled with respect to the display region 710 with no change in the presentation, the scrolling continues unnoticed by the user. Thus, a portion of the list 700 is scrolled unnoticed, and the user can neither confirm nor correct a combination included in such a portion. To avoid such a circumstance, for example, an upper limit may be set to the number of combinations having the “low certainty factor” 704 that remain in the display region 710. The upper limit is smaller than the maximum number of combinations that can be presented in the display region 710. For example, the upper limit may be set at around half or a fraction of the maximum number. If the number of combinations having the “low certainty factor” 704 that remain in the display region 710 exceeds the upper limit, the check-and-correction processor 100 removes from the display region 710 a combination having the “low certainty factor” 704 that remains for the longest period. Thus, the number of combinations having the “low certainty factor” 704 that remain in the display region 710 is maintained at the upper limit or less. Due to this control, a region is maintained in the display region 710 to present in scrolling presentation at least one combination other than the combinations having the “low certainty factor” 704 that remain in the display region 710.

In the example depicted in FIGS. 7A to 7C, a combination having the “low certainty factor” 704 that has been neither confirmed nor corrected is caused to remain in the display region 710 by way of example only. Instead of this example, the check-and-correction processor 100 may display another window to present a list of such combinations as move out of the display region 710 due to scrolling.

The control in the first modification and the control in the second modification may be applied in combination. When the control in these modifications is used in combination, the control in the second modification is adopted while a list is presented and scrolled in the list-presentation section 220. Then, when the list is scrolled up to the end or the focus operated by the user moves out of the list-presentation section 220, the control in the first modification may be adopted.

In the exemplary embodiment and modifications described above, combinations in a list are classified into two groups, which are a group having a high certainty factor and a group having a low certainty factor, by way of example only. As another example, more than two levels may be set for the certainty factor. For example, combinations having the “low certainty factor” 304 in the above exemplary embodiment may be divided into a plurality of levels in accordance with the level of the certainty factor.

In this case, as the level of the certainty factor of a combination presented in the list-presentation section 220 decreases, the scrolling-speed controller 104 may decrease the scrolling speed. As the level of the certainty factor of a combination presented in the list-presentation section 220 decreases, for example, the amount of delay in scrolling is increased in step 426 in the procedure in FIG. 4. In this case, the scrolling-speed controller 104 may adopt, for example, a scrolling speed based on the level to which the lowest of the certainty factors of the combinations presented in the list-presentation section 220 belongs.

In the exemplary embodiment and modifications described above, attention is paid only to whether at least one combination having the “low certainty factor” 304 or 704 is included in the list-presentation section 220. In addition, the scrolling speed may be controlled by paying attention to the number of combinations having the “low certainty factor” 304 or 704 in the list-presentation section 220. For example, as the number of combinations having the “low certainty factor” 304 or 704 increases in the list-presentation section 220, the scrolling speed is decreased.

In the exemplary embodiment and modifications described above, switching the scrolling speeds is determined based on whether at least one combination having the “low certainty factor” 304 or 704 is included in the display region 310 or 710 of the list-presentation section 220 by way of example only. For example, an extended region may be set, and the scrolling speed may be decreased while at least one combination having the “low certainty factor” 304 or 704 is included in the extended region. Such an extended region is set by adding a predetermined number of rows to the display region 310 or 710 in the scrolling direction (that is, the direction pointed by the key pressed by the user). By using the extended region in this way, the scrolling speed is decreased immediately before a combination having the “low certainty factor” 304 or 704 enters the display region 310 or 710 by scrolling. The display regions 310 and 710 and the extended region mentioned above are examples of “a corresponding region associated with the display region”.

In the above examples, descriptions have been given in the cases where commands to scroll a list are sent by pressing an arrow key by way of example only. The control in the exemplary embodiment and modifications described above can be applied in the case of other operations to send commands to scroll a list, such as rolling a wheel on a mouse and pressing a GUI button for a scrolling operation in a screen.

Although the above examples concern character recognition, the control in the exemplary embodiment and modifications described above can also be applied in the case of recognition of visual representations other than characters (for example, images). For example, the list presentation and the list scrolling control illustrated above can be applied to a system in which a user confirms or corrects a recognition result obtained by an object recognition system that recognizes a type of object included in an image.

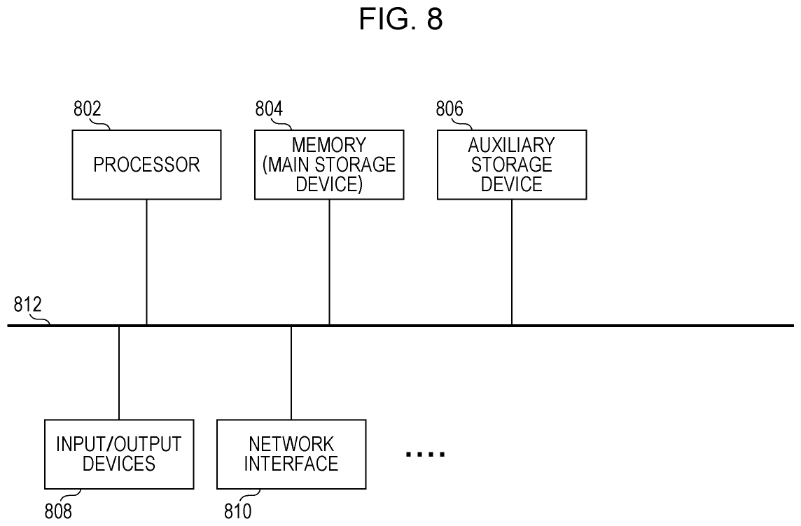

The information processing apparatus that performs the control in the exemplary embodiment and modifications described above can be constructed by using hardware of a general-purpose computer. FIG. 8 depicts an example of a major portion of a hardware configuration of a general-purpose computer 800, which can be used as a basis of the information processing apparatus.

As illustrated in FIG. 8, the computer 800 has a circuit configuration in which a processor 802, a memory (main storage device) 804 such as a random-access memory (RAM), a controller that controls an auxiliary storage device 806 formed of a non-volatile storage device, such as a flash memory, a solid state drive (SSD), or a hard disk drive (HDD), an interface to connect to various input/output devices 808, a network interface 810 that performs control to connect to a network such as a local area network, and other devices are connected, for example, by using a data transmission line such as a bus 812. Details of the processes and control in the exemplary embodiment or modifications described above are described in a program, and the program is installed into the computer hardware via a network or the like and stored in the auxiliary storage device 806. The program stored in the auxiliary storage device 806 is loaded into the memory 804 and executed by the processor 802, and the information processing apparatus according to the present exemplary embodiment is realized.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
acquire (i) a list of combinations of an image and a recognition result of the image and (ii) information regarding certainty factors of the recognition results,
display the list in a display region in a scrollable manner, and
scroll the list in response to a predetermined operation,
wherein a scrolling speed of the scrolling is controlled in accordance with the certainty factors.

2. The information processing apparatus according to claim 1,
wherein the scrolling speed of the scrolling is controlled to be slower when a displayed portion of the list that is being displayed in the display region includes a recognition result with a certainty factor lower than a threshold than when the displayed portion of the list that is being displayed in the display region includes no recognition result with a certainty factor lower than the threshold.

3. The information processing apparatus according to claim 2,
wherein the processor is configured to, among the recognition results in the list, treat any user-corrected or user-confirmed recognition result having a certainty factor lower than the threshold as a recognition result having a certainty factor equal to or higher than the threshold.

4. The information processing apparatus according to claim 1,
wherein the processor is configured to, among the recognition results in the list, inform a user of a low-certainty recognition result that has a certainty factor lower than a threshold, upon a determination that the low-certainty recognition result has been displayed in the display region for review but no correction or confirmation for the low-certainty recognition result has been received from the user.

5. The information processing apparatus according to claim 2,
wherein the processor is configured to, among the recognition results in the list, inform a user of a low-certainty recognition result that has a certainty factor lower than a threshold, upon a determination that the low-certainty recognition result has been displayed in the display region for review but no correction or confirmation for the low-certainty recognition result has been received from the user.

6. The information processing apparatus according to claim 3,
wherein the processor is configured to, among the recognition results in the list, inform a user of a low-certainty recognition result that has a certainty factor lower than a threshold, upon a determination that the low-certainty recognition result has been displayed in the display region for review but no correction or confirmation for the low-certainty recognition result has been received from the user.

7. The information processing apparatus according to claim 4,
wherein the processor is configured to inform the user of the low-certainty recognition result by displaying an informing screen indicating that no correction or confirmation has been made for the low-certainty recognition result, and
wherein the informing screen is displayed after the scrolling has gone through all the combinations in the list.

8. The information processing apparatus according to claim 5,
wherein the processor is configured to inform the user of the low-certainty recognition result by displaying an informing screen indicating that no correction or confirmation has been made for the low-certainty recognition result, and
wherein the informing screen is displayed after the scrolling has gone through all the combinations in the list.

9. The information processing apparatus according to claim 6,
wherein the processor is configured to inform the user of the low-certainty recognition result by displaying an informing screen indicating that no correction or confirmation has been made for the low-certainty recognition result, and
wherein the informing screen is displayed after the scrolling has gone through all the combinations in the list.

10. The information processing apparatus according to claim 4,
wherein the processor is configured to inform the user of the low-certainty recognition result by displaying an informing screen indicating that no correction or confirmation has been made for the low-certainty recognition result, and
wherein the informing screen is displayed in response to a focus of the user moving out of the display region.

11. The information processing apparatus according to claim 5,
wherein the processor is configured to inform the user of the low-certainty recognition result by displaying an informing screen indicating that no correction or confirmation has been made for the low-certainty recognition result, and
wherein the informing screen is displayed in response to a focus of the user moving out of the display region.

12. The information processing apparatus according to claim 6,
wherein the processor is configured to inform the user of the low-certainty recognition result by displaying an informing screen indicating that no correction or confirmation has been made for the low-certainty recognition result, and
wherein the informing screen is displayed in response to a focus of the user moving out of the display region.

13. The information processing apparatus according to claim 4,
wherein the processor is configured to inform the user of the low-certainty recognition result by displaying the low-certainty recognition result together with the image from which the low-certainty recognition result has been obtained in response to the low-certainty recognition result moving out of the display region by the scrolling.

14. The information processing apparatus according to claim 5,
wherein the processor is configured to inform the user of the low-certainty recognition result by displaying the low-certainty recognition result together with the image from which the low-certainty recognition result has been obtained in response to the low-certainty recognition result moving out of the display region by the scrolling.

15. The information processing apparatus according to claim 6,
wherein the processor is configured to inform the user of the low-certainty recognition result by displaying the low-certainty recognition result together with the image from which the low-certainty recognition result has been obtained in response to the low-certainty recognition result moving out of the display region by the scrolling.

16. The information processing apparatus according to claim 1,
wherein the scrolling speed of the scrolling correlates with a certainty factor of a displayed recognition result that is being displayed in a display region, and
wherein the lower the certainty factor of the displayed recognition result is, the slower the scrolling speed of the scrolling becomes.

17. An information processing apparatus comprising:
means for acquiring (i) a list of combinations of an image and a recognition result of the image and (ii) information regarding certainty factors of the recognition results;
means for displaying the list in a display region in a scrollable manner; and
means for scrolling the list in response to a predetermined operation,
wherein a scrolling speed of the scrolling is controlled in accordance with the certainty factors.
